(19) United States
(12) Patent Application Publication
(10) Pub. No.: US 2010/0212526 A1
(43) Pub. Date: Aug. 26, 2010

(54) Method for Producing a Printed Product

(76) Inventors: Peter Schulmeister, Pfaffenhofen (DE); Robert Weiss, Gersthofend (DE); Florian Fejfar, Munchen (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/680,713

(22) PCT Filed: Sep. 26, 2008
(86) PCT No.: PCT/EP08/08218

§ 371 Date: Mar. 29, 2010

(30) Foreign Application Priority Data
Sep. 29, 2007 (DE) 10 2007 046 772.0

(51) Int. Cl. B41F 3/34; B41J 2/01

(52) U.S. Cl. 101/492; 347/104

(57) ABSTRACT

A method for producing a printed product on a web press, wherein a plurality of printing substrate webs which are to be printed are held ready at a plurality of reel splicers of the web press. The plurality of printing substrate webs are transported respectively through at least one printing form-based printing unit of the web press for the static printing of an image on the plurality of printing substrate webs which does not change for printed copies of the printed product. In addition to, particularly in-line with, the static printing, at least one of the statically printed printing substrate webs is printed dynamically in the region of at least one printing device of the web press without a printing form with an image which is variable for at least some printed copies, and statically printed printing substrate webs and statically and dynamically printed printing substrate webs are joined and processed to form a multi-page printed product in the region of at least one turning and mixing stage and at least one folder of the web press such that the printed product is dynamically printed on at least one printed page of the printed product located inside of the printed product.

### CROSS-REFERENCE TO RELATED APPLICATIONS

This is a U.S. national stage of International Application No. PCT/EP2008/008218, filed on 26 Sep. 2008. Priority is claimed on German Application No. 10 2007 046 772.0, filed on 29 Sep. 2007.

### BACKGROUND OF THE INVENTION

1. Field of the Invention

The invention is directed to a method for producing a printed product.

2. Description of the Related Art

Web presses have printing form-based printing units for statically printing at least one printing substrate web with a printed image which is the same for all printed copies of a printed product. Every printed copy usually comprises a plurality of printed pages.

Such known form-based printing units, which serve for static printing on the printing substrate web, or on each printing substrate web, are typically constructed as offset printing units. It is also possible that printing form-based printing units are constructed as intaglio printing units.

It is already known in practice to provide in a web press, in addition to the printing form-based printing units serving for static printing of the printing substrate web, or of each printing substrate web, with a printed image which is the same for all printed copies, at least one printing device having no printing form so as to individualize printed copies in addition to, particularly in-line with, the static printing, i.e., to dynamically print at least one printing substrate web with a printed image which varies for at least some printed copies.

A printing device of this kind without a printing form can be an inkjet printing device or an electrophotographic printing device, such as a laser printing device or an ionographic printing device.

When a printed product is produced on a web press in accordance with known practices in that a plurality of printing substrate webs are statically printed by printing form-based printing units and in addition to this, particularly in-line therewith, at least one of the statically printed printing substrate webs is dynamically printed by a printing form device having no printing form, a printed product is always produced in which the dynamic printing is formed at the finished printed product on an outer page of the printed product and is accordingly visible from the outside without unfolding the printed product. However, when printing in this matter, products can be individualized only to a limited extent.

### SUMMARY OF THE INVENTION

It is therefore an object of the present invention to provide a method for producing a printed product.

This and other objects and advantages are achieved in accordance with the invention by a method in which printing substrate webs that are to be printed are held ready at a plurality of reel splicers of a web press, wherein the plurality of printing substrate webs are transported respectively through at least one printing form-based printing unit of the web press for static printing of the plurality of printing substrate webs with a printed image remains unchanged for printed copies of the printed product. In addition to, particularly in-line with, the static printing, at least one of the statically printed printing substrate webs is printed dynamically in the region of at least one printing device of the web press without a printing form with a printed image which is variable for at least some printed copies. Statically printed printing substrate webs and statically and dynamically printed printing substrate webs are joined and processed to form a multi-page printed product in the region of at least one turning and mixing stage and at least one folder of the web press such that the printed product is dynamically printed on at least one printed page of the printed product inside of the printed product.

In accordance with the method of the invention, a printed product is provided such that a plurality of printing substrate webs are statically printed by printing form-based printing units, at least one of the statically printed printing substrate webs is printed dynamically by at least one printing device having no printing form, and statically printed printing substrate webs and statically and dynamically printed printing substrate webs are joined and folded such that the printed product is dynamically printed on at least one inside page of the printed product. Here, the dynamic printing of the printed product is only visible to a purchaser of the printed product when the purchaser unfolds the printed product. This is entirely unknown in the art.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiment examples of the invention are described more fully with reference to the drawings without limiting the invention, in which:

FIG. 1 is a schematic block diagram of a web press having a plurality of reel splicers.

FIG. 2 is a flow chart of the method in accordance with an embodiment of the invention.

### DETAILED DESCRIPTION OF THE PREFERRED EMBODIMENTS

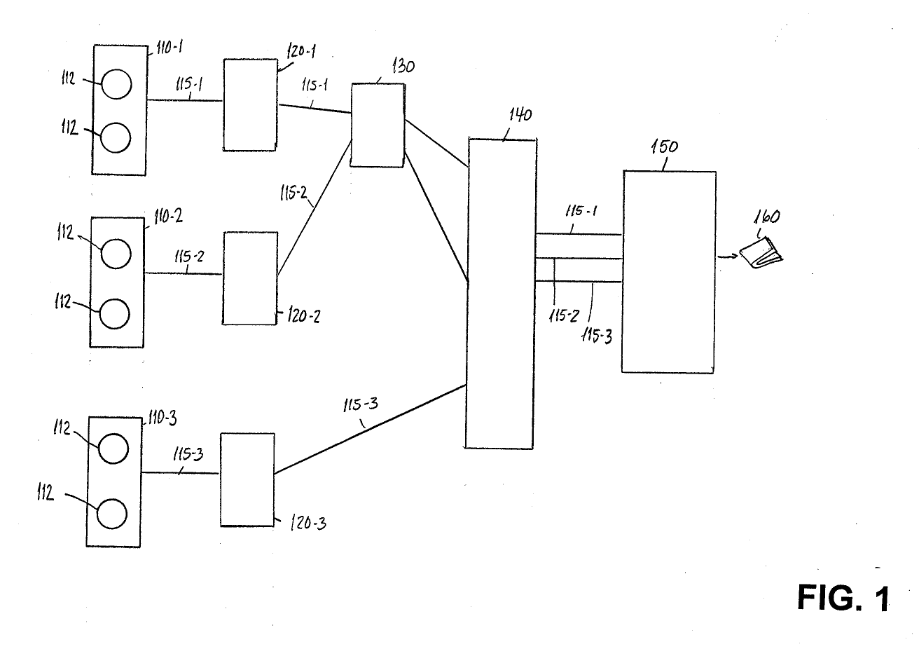

The present invention is directed to a method for producing a printed product on a web press. As shown in FIG. 1, a web press 100 has a plurality of reel splicers 110-1, 110-2, 110-3, where a plurality of printing substrate webs 115-1, 115-2, 115-3 (collectively printing substrate webs 115) in the form of rolls 112 of printing stock are held at the ready on the reel splicers 110-1, 110-2, 110-3 of the web press. The printing substrate webs 115 are then drawn off the printing stock rolls 112 for printing in the area of the reel splicers 110-1, 110-2, 110-3. The plurality of printing substrate webs 115 drawn off in the region of the reel splicers 110-1, 110-2, 110-3 are transported through respective printing form-based printing units 120-1, 120-2, 120-3 (collectively referred to as printing form-based printing units 120) of the web press so as to be statically printed with a printed image which does not change in printed copies of a printed product, where every printing substrate web 115-1, 115-2, 115-3 is statically printed in the region of at least one printing form-based printing unit 120. The printing form-based printing units 120 are preferably offset printing units. It is also possible that the printing form-based printing units are designed as intaglio printing units or as coating units, or flexographic printing units. Different printing form-based printing units can also be combined in a web-fed rotary press.

All of the printing form-based printing units 120 share the common feature that they serve to provide static printing of the printing substrate webs with a printed image that stays the same for the printed copies of a print job.

After the static printing of the plurality of printing substrate webs, at least one of the statically printed printing substrate webs 115-1, 115-2, in addition to, particularly in-line with, the static printing, is printed dynamically in the region of at least one printing device 130 of the web press without a printing form with a printed image which is variable for at least some printed copies. Here, a plurality of printing substrate webs are preferably dynamically printed respectively by at least one printing device 130 without a printing form. In FIG. 1, the webs 115-1 and 115-2 are led to the printing device 130 without a printing form. Alternatively, each of these webs 115-1, 115-2 could be led to a separate printing device 130.

The printing devices 130 without printing forms are preferably inkjet printing devices. Alternatively, they can also be electrophotographic printing devices, such as laser printing devices or ionographic printing devices. It is also possible to use different printing devices without printing forms in a web press for dynamic printing of at least one printing substrate web.

In the region of the printing device 130 without a printing form, or of each printing device without a printing form, at least one printing substrate web 115-1, 115-2 is printed with a dynamic printed image, where the dynamic printed image is text, pictures, numbers and/or codes, such as barcodes. The dynamic printing in the region of the printing device without a printing form, or of each printing device 130 without a printing form, can be performed with one or more colors.

Preferably, printing substrate webs with a width greater than one meter are printed in the printing form-based printing units 120 and in the printing devices 130 without a printing form.

Preferably, at least two pages, i.e., at least four pages, preferably at least six pages, are printed side by side on a printing substrate web considered in the axial direction of the printing substrate web.

The static printing and the dynamic printing of the printing substrate webs 115-1, 115-2 is performed at a printing speed of at least 7 m/sec, preferably at a printing speed of at least 10 m/sec. When the static printing and the dynamic printing is performed in-line, the static printing and dynamic printing are performed at the same printing speed.

In the region of at least one turning and mixing stage 140 and at least one folder 150 of the web press, statically printed printing substrate webs 115-3 and statically and dynamically printed printing substrate webs 115-1, 115-2 are joined and processed, i.e., folded, to form a multi-page printed product 160 such that the printed product is dynamically printed on at least one page of the printed product located inside the printed product. The dynamic printing can be performed on a plurality of inner pages and optionally also on at least one outer page of the printed product.

The method is preferably used for producing a newspaper. A newspaper typically comprises one or more books, each book comprising a plurality of outer printed pages and a plurality of inner printed pages. Within the meaning of the invention, a newspaper is produced such that at least one inner page of the book is dynamically printed in the region of at least one book of the newspaper.

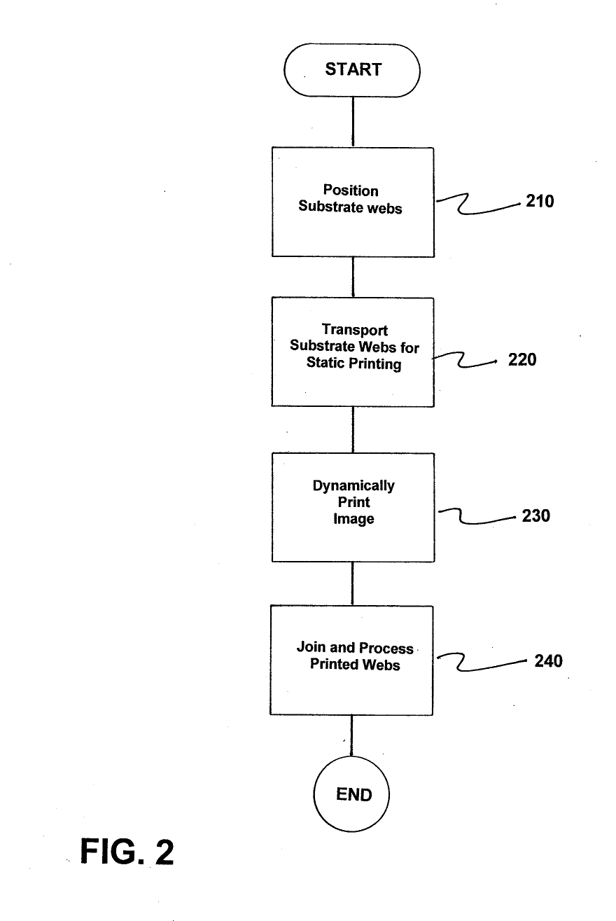

FIG. 2 is a flow chart of the method for producing a printed product on a web press in accordance with the invention. The method comprises positioning a plurality of printing substrate webs which are to be printed at a plurality of reel splicers of the web press, as indicated in step 210. The plurality of printing substrate webs are transported through at least one printing form-based printing unit of the web press for static printing of an image on the plurality of printing substrate webs, as indicated in step 220. Here, the printed image remaining unchanged for all printed copies of the printed product.

The image is dynamically printed on at least one of the statically printed plurality of printing substrate webs in a region of at least one printing device of the web press without a printing form, as indicated in step 230. In this case, the printed image is variable for at least some printed copies.

The statically printed plurality of substrate webs and the at least one statically and dynamically printed plurality of printing substrate webs are joined and processed to form a multi-page printed product in the region of at least one turning and mixing stage and at least one folder of the web press such that the multi-page printed product is dynamically printed on at least one printed page of the printed product located inside of the printed product, as indicated in step 240. Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for producing a printed product on a web press, comprising:
positioning a plurality of printing substrate webs which are to be printed at a plurality of reel splicers of the web press;
transporting each of the plurality of printing substrate webs through a respective at least one printing form-based printing unit of the web press for static printing of a static image on the plurality of printing substrate webs, the printed static image remaining unchanged for all printed copies of the printed product;
dynamically printing a further image on at least one of the statically printed plurality of printing substrate webs in a region of at least one printing device of the web press without a printing form, the further printed image being variable for at least some printed copies; and
joining and processing the statically printed plurality of substrate webs and the at least one statically and dynamically printed plurality of printing substrate webs to form a multi-page printed product in the region of at least one turning and mixing stage and at least one folder of the web press such that the multi-page printed product is dynamically printed on at least one printed page of the printed product located inside of the printed product.

10. The method according to claim 9, wherein the printing form-based printing units are offset printing units.

11. The method according to claim 9, wherein each at least one printing device without the printing form is an inkjet printing device.

12. The method according to claim 10, wherein each at least one printing device without the printing form is an inkjet printing device.

13. The method according to claim 9, wherein the plurality of printing substrate webs are printed with a width greater than one meter.

14. The method according to claim 9, wherein the plurality of printing substrate webs are printed at a printing speed of greater than 7 m/sec.

15. The method according to one of claim 14, wherein the plurality of printing substrate webs are printed at a printing speed of at least 10 m/sec.

16. The method according to claim 9, wherein said at least one of the statically printed plurality of printing substrate webs is printed with a single-color variable printed image in one of the region of the at least one printing device without the printing form.

17. The method according to claim 9, wherein said at least one of the statically printed plurality of printing substrate webs is printed with a multi-color variable printed image in the region of the at least one printing device without the printing form.

18. The method according to claim 9, wherein said at least one of the statically printed plurality of printing substrate webs is printed with a variable printed image comprising text, graphics and codes in the region of the at least one printing device without the printing form.

19. The method according to claim 9, wherein said step of dynamically printing is performed in line with the static printing.
